(19) United States
(12) Patent Application Publication
(10) Pub. No.: US 2023/0175482 A1
(43) Pub. Date: Jun. 8, 2023

(54) Self-Centering Plunger for Hydraulic Yaw Brake

(71) Applicant: Wind Solutions, LLC, Sanford, NC (US)

(72) Inventors: Bradley Keith Baldwin, Hudson, OH (US); Christopher James Winslow, Lemon Springs, NC (US); Matthew Kenneth King, Carthage, NC (US)

(73) Assignee: Wind Solutions, LLC, Sanford, NC (US)

(21) Appl. No.: 18/071,921

(22) Filed: Nov. 30, 2022

Related U.S. Application Data
(60) Provisional application No. 63/420,150, filed on Oct. 28, 2022.
(60) Provisional application No. 63/285,620, filed on Dec. 3, 2021.

(51) Int. Cl. F03D 7/02; F03D 80/70

(52) U.S. Cl. CPC F03D 7/0204; F03D 80/70; F05B 2260/902; F05B 2270/329

(57) ABSTRACT

An apparatus for a self-centering plunger for a hydraulic yaw brake having improved load distribution and ability to accommodate system forces, torques, stresses, etc. is disclosed. A lower section of the self-centering hydraulic plunger has a reduced diameter and does not include a bottom collar, which minimizes torque transfer from a brake piston. A brake piston seat washer is thicker, more robust and has increased surface area to better distribute the load onto the brake piston. The geometry of the piston seat washer also minimizes the torque transferred from the brake piston to the self-centering hydraulic plunger. A friction sleeve assembly improves load distribution at a plunger-housing interface by improving sliding contact surface area.

### CROSS-REFERENCE TO RELATED APPLICATIONS

This application claims the benefit of U.S. Provisional Patent Application No. 63/285,620, filed on Dec. 3, 2021, and U.S. Provisional Patent Application No. 63/420,150, filed on Oct. 28, 2022, the entire contents of which are hereby incorporated by reference.

### BACKGROUND

The present disclosure relates to wind turbines. More particularly, the present disclosure relates to yaw brakes for wind turbines.

A wind turbine includes a nacelle and a tower that supports the nacelle through a rotational coupling, allowing the nacelle to rotate relative to the tower, in yaw. Generally, utility-scale wind turbines incorporate one or more hydraulic yaw brakes to control or prevent rotation of the nacelle, when such rotation is undesired. The hydraulic yaw brakes must absorb large static and dynamic loads created by forces, moments and other stresses during wind turbine operation, yet have an extended service life.

### BRIEF DESCRIPTION OF THE DRAWINGS

FIG. 1 depicts a cutaway view of the upper portion of a wind turbine, in accordance with an embodiment of the present disclosure.

FIGS. 2A and 2B depict views of a hydraulic yaw brake, in accordance with an embodiment of the present disclosure.

FIGS. 3A and 3B depict views of a hydraulic plunger, brake piston, piston seat washer and brake friction pad, in accordance with an embodiment of the present disclosure. FIG. 3C depicts an exterior view of a hydraulic plunger, in accordance with an embodiment of the present disclosure.

FIGS. 4A and 4B depict views of a self-centering hydraulic plunger, brake piston, piston seat washer and brake friction pad, in accordance with an embodiment of the present disclosure.

FIGS. 5A to 5C depict views of a self-centering hydraulic plunger, brake piston and piston seat washer, in accordance with an embodiment of the present disclosure.

FIGS. 6A and 6B depict views of a piston seat washer, in accordance with an embodiment of the present disclosure.

FIGS. 7A to 7C depict views of a self-centering hydraulic plunger, in accordance with an embodiment of the present disclosure.

FIGS. 8A to 8C depict views of a self-centering hydraulic plunger, brake piston, piston seat washer and brake friction pad, in accordance with embodiments of the present disclosure.

FIGS. 9A to 9D depict views of a self-centering hydraulic plunger and a friction sleeve assembly, in accordance with an embodiment of the present disclosure. FIG. 9E depicts a cross section view of a friction sleeve assembly, in accordance with an embodiment of the present disclosure. FIG. 9F depicts an exterior view, from below, of a yaw brake housing, in accordance with an embodiment of the present disclosure.

FIGS. 10A to 10E depict views of a sleeve portion, in accordance with an embodiment of the present disclosure.

### DETAILED DESCRIPTION

Embodiments of the present disclosure will now be described with reference to the drawing figures, in which like reference numerals refer to like parts throughout.

Embodiments of the present disclosure advantageously provide an apparatus for a self-centering plunger for a hydraulic yaw brake. More particularly, embodiments of the present disclosure advantageously provide a self-centering plunger for a hydraulic yaw brake having improved load distribution and ability to accommodate system forces, torques, stresses, etc.

A wind turbine includes a set of wind turbine blades, a nacelle, and a tower that supports the nacelle through a rotational coupling. The nacelle includes a rotor shaft with a hub to which the wind turbine blades are attached. The hub is rotationally coupled to an electrical generator, and the wind turbine converts wind energy to electrical energy by converting the aerodynamic forces (i.e., lift) imparted onto the turbine blades by the wind into rotation of the drive shaft of the electrical generator to produce electricity.

The nacelle includes a yaw system that holds the nacelle pointed into the wind, or that otherwise provides a resistance or damping to the rotation of the nacelle about the vertical axis of the tower. Generally, a yaw system for a utility-scale wind turbine may include yaw bearings to rotationally couple the nacelle to the tower, yaw brakes to control the rotation of the nacelle, and yaw drives to actively slew the nacelle to a desired direction.

In many wind turbines, the yaw system includes a number of hydraulic yaw brakes that are mounted to the frame of the nacelle. Each hydraulic yaw brake includes a hydraulic actuator that is coupled to a brake friction pad that engages a bearing surface at the top of the tower known as a slew ring. The hydraulic yaw brakes must absorb large static and dynamic loads created by forces and moments during wind turbine operation. In many cases, the components that couple the hydraulic actuator to the pad, as well as the pad itself, are inadequately designed and fail prematurely due to poor load distribution and ability to accommodate the system forces, torques, stresses, etc.

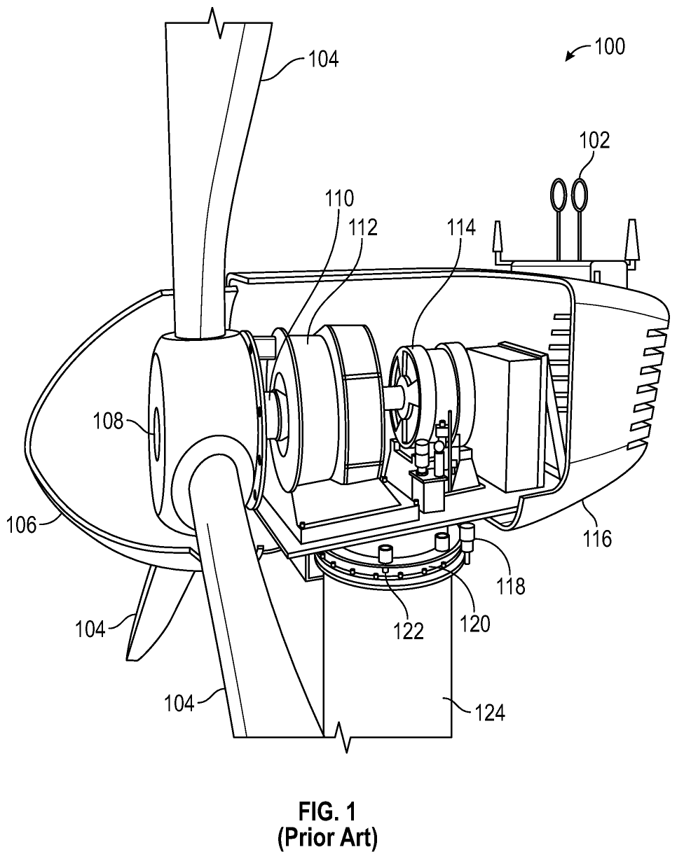

FIG. 1 depicts a cutaway view of the upper portion of wind turbine 100, in accordance with the present disclosure. Wind turbine 100 includes, inter alia, a set of wind turbine blades 104, nacelle116, and tower 124 that supports nacelle 116 through a rotational coupling. Nacelle 116 includes rotor shaft 110, coupled to hub 108, to which wind turbine blades 104 are attached. The wind striking turbine blades 104 creates lift which causes hub 108 to rotate rotor shaft 110, which is coupled to gearbox 112 and electrical generator 114 within nacelle 116, which converts the mechanical rotation into electricity. The orientation of turbine blades 104 with respect to hub 108 (their “pitch”) most often is variable, and is controlled to maintain the desired speed of the turbine through variable wind conditions.

Nacelle 116 also includes a yaw system which generally provides a set of components structurally configured to facilitate the orientation of nose cone 106 and turbine blades 104 towards the wind. The yaw system may include yaw bearings to rotationally couple the nacelle to the tower and yaw drives 118 with associated motors, gearboxes and drive pinions to actively slew nacelle 116 to a desired direction. Mechanical or hydraulic yaw brakes 122 are utilized hold, lock, or otherwise steady the orientation or yaw position of nacelle 116. Generally, wind turbines 100 include anemometer 102 that detects wind direction and speed and sends signals via a controller (e.g., a programmable logic controller, microcontroller, processor, etc.) to the components of the yaw system to adjust and then hold the yaw position of nacelle 116.

A series of hydraulic yaw brakes 122 are coupled together and activated by a hydraulic power station within the nacelle. Each yaw brake 122 is attached within the nacelle framework and engages slew ring 120 of the tower, which is a large diameter disk made of steel, etc. Slew ring 120 includes an outer or inner rim gear to engage the drive pinions of yaw drives 118.

Each hydraulic brake 122 includes a brake piston with a brake friction pad attached. The brake friction pad is structurally designed through force and friction to control rotation of the nacelle of the wind turbine, to provide relatively smooth rotation of the nacelle into the wind under a wide range of weather conditions, and to brake or stop the rotation of the nacelle at a particular orientation.

The brake friction pad may include a dry or lubricated pad that bears against the slew ring, and may be made from metal, such as brass, bronze, sintered bronze, oil impregnated bronze, etc., polymer, composite, sintered metal, polyether ether ketone (PEEK), layered synthetic fiber reinforced formulation having a wear layer of polyester resin and fabric with polytetrafluoroethylene (PTFE) fibers, etc. The brake friction pad is also referred to as a yaw bearing, a gliding yaw pad, a gliding yaw bearing, a yaw bearing pad, a yaw brake pad, a yaw puck, etc.

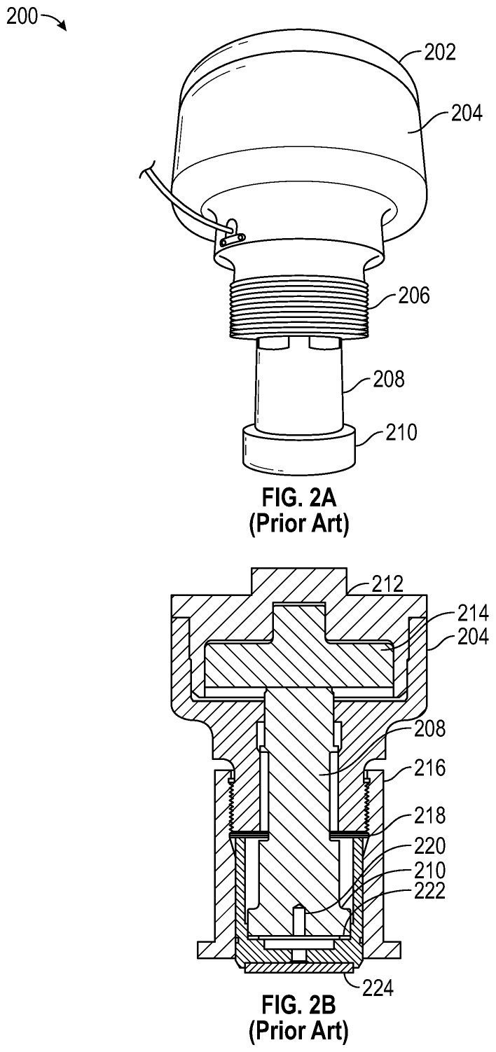

FIGS. 2A and 2B depict views 200 of a hydraulic yaw brake 122, in accordance with the present disclosure. FIG. 2A depicts an exterior view, while FIG. 2B depicts a cross-sectional view. The hydraulic pressure within the brake from hydraulic actuator 202 transfers a force from hydraulic piston 214 to hydraulic plunger 208, then to piston seat washer 222 and finally to brake piston 218 and brake friction pad 224. The upper surface of hydraulic plunger 208 contacts hydraulic piston 214, and the bottom surface contacts piston seat washer 222 disposed within brake piston 218. Hydraulic plunger 208 encompasses a hexagonal design to restrict rotation within the housing and central tapped hole 220 to facilitate easy extraction from housing 204 and frame 216. The components that transfer the force to brake friction pad 224, i.e., hydraulic plunger 208, piston seat washer 222, brake piston 218, as well as brake friction pad 224 itself, frequently are inadequately designed and fail prematurely during operation of wind turbine 100, due to poor load distribution and ability to accommodate the system forces, torques, stresses, etc.

In one example, typical activation of hydraulic actuator 202 generates 67,442 lbf (300 kN) of force on piston seat washer 222 with a surface area of 2.4 in², which generates 67,442 lbf/2.4 in²=28,100 psi (194 MPa) on brake piston 218. In this example, brake piston 218 is bronze (CuSn12) with a yield strength of 20,305 psi (140 MPa), so the force applied to brake piston 218 exceeds the yield strength of the material, which produces deformation, cracking, shearing, etc. Additionally, brake piston 218 intermittently rotates very slowly about the bottom collar (e.g., <1 rpm) due to the rotation of nacelle 116. The rotation of the bronze piston may transfer more than 700ft⋅bf (950 N⋅m) of torque to hydraulic plunger 208 producing undesirable side loads and torque to brake piston 218, undesirable side loading of hydraulic plunger 208, undesirable shear forces in the bronze piston, etc. The adverse effects of the side loads can cause wear to the hexagonal portion of hydraulic plunger 208 as well as hydraulic leaks if hydraulic piston 214 rotates.

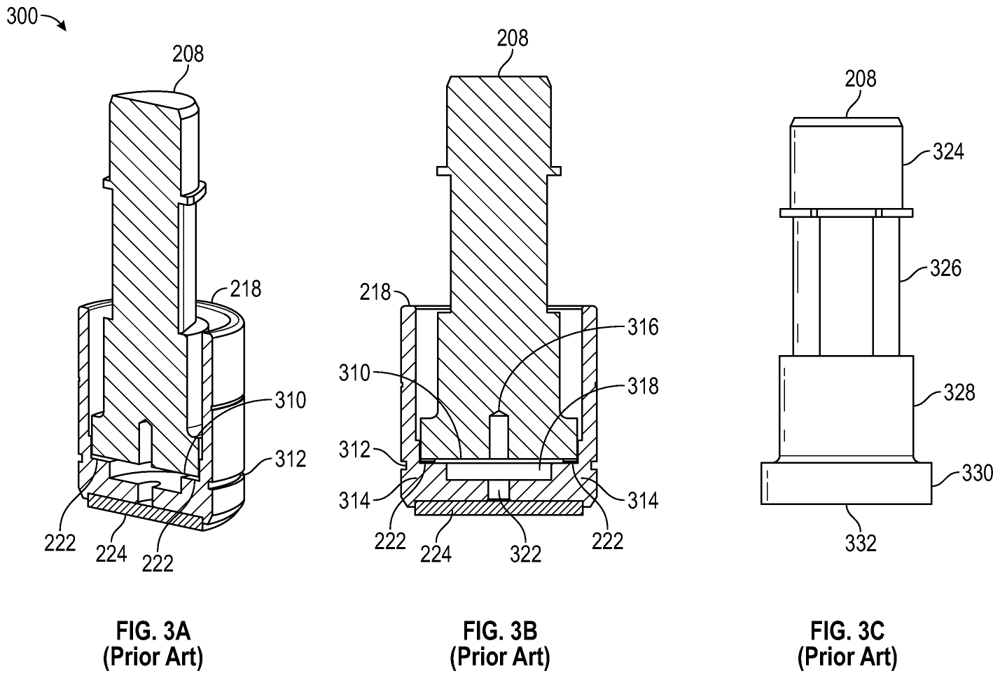

FIGS. 3A, 3B and 3C depict views 300 of hydraulic plunger 208, brake piston 218, piston seat washer 222 and brake friction pad 224 (FIGS. 3A and 3B) and hydraulic plunger 208 (FIG. 3C), in accordance with the present disclosure. FIG. 3A depicts a perspective cross-sectional view, FIG. 3B depicts a cross-sectional view, and FIG. 3C depicts an exterior view.

The hydraulic plunger includes upper section 324 with an upper surface that contacts hydraulic piston 214, middle section 326, and lower section 328 with bottom collar 330 with lower surface 332 that contacts piston seat washer 222 disposed within brake piston 218.

Brake piston 218 has a cylindrical body, a side wall that defines an inner space, an open upper end and a closed lower end or base. The base of the brake piston includes an interior surface with recess 318 and shelf 320, an exterior surface to which brake friction pad 224 is attached, O-ring groove 312, and central hole 322.

Piston seat washer 222 is disposed on shelf 320 within brake piston 218, and brake friction pad 224 is attached to the lower exterior surface of brake piston 218 by a form of adhesive. A portion (e.g., one-third) of the lower surface of the bottom collar (bottom collar surface 310) contacts piston seat washer 222. In the example described above, the inner diameter of brake piston 218 is 80 mm, and the diameter of brake friction pad 224 is 80 mm.

Embodiments of the present disclosure advantageously provide a self-centering hydraulic plunger for a hydraulic yaw brake. The lower section of the self-centering hydraulic plunger has a reduced diameter and does not include a bottom collar, which minimizes torque transfer from the brake piston. The brake piston seat washer is thicker, more robust and has increased surface area to better distribute the load onto the brake piston. The geometry of the piston seat washer also minimizes the torque transferred from the brake piston to the self-centering hydraulic plunger. In certain embodiments, a guide band is disposed in the piston seat washer to support side loads of the self-centering hydraulic plunger.

Additionally, static and dynamic pressure on the brake friction pad is reduced 28% by increasing the diameter of the pad from 80 mm (a pad area of 5026 mm²=7.79 in²) to 94 mm (a pad area of 6940 mm²=10.75 in²). For the example described above, the static pressure applied to the 80 mm brake friction pad by the hydraulic actuator is 8,657 psi (i.e., 67,440 lbf/7.79 in²), while the static pressure applied to the 94 mm brake friction pad by the hydraulic actuator is 6,273 psi (i.e., 67,440 lbf/10.75 in²).

The thickness of the lower surface or base of the brake piston has been increased by 19 mm (with a corresponding decrease in hydraulic plunger length), and the thickness of the side wall of the brake piston has been increased by 2 mm, thereby reducing the inner diameter to 76 mm.

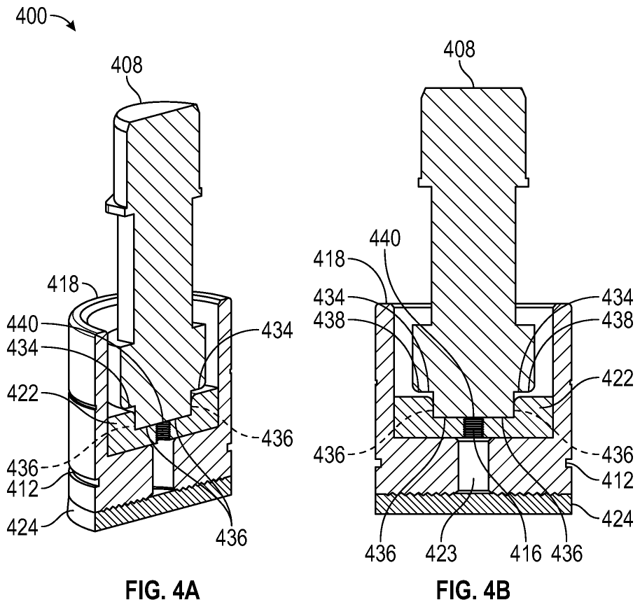

FIGS. 4A and 4B depict views 400 of a self-centering hydraulic plunger, brake piston, piston seat washer and brake friction pad, in accordance with an embodiment of the present disclosure. FIG. 4A depicts a perspective cross-sectional view, while FIG. 4B depicts a cross-sectional view.

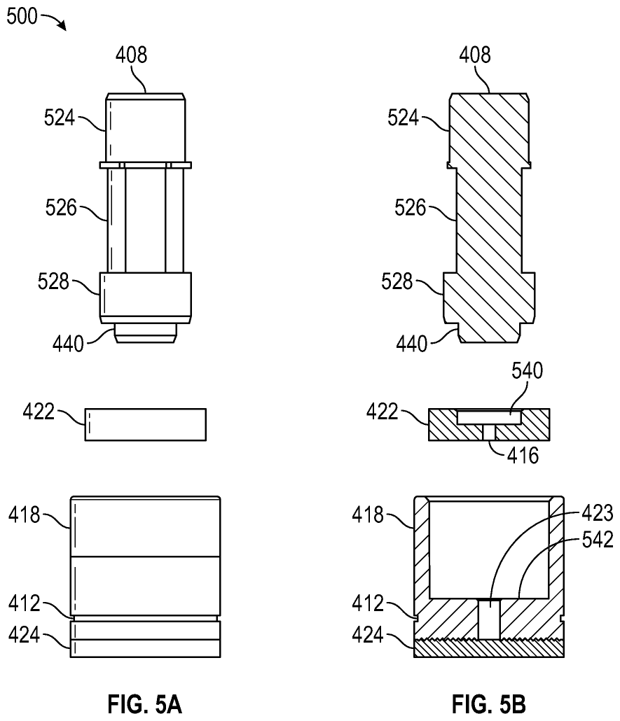

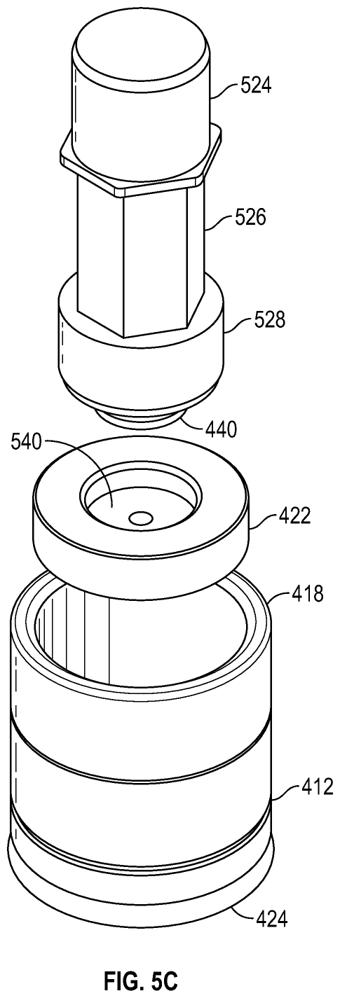

FIGS. 5A, 5B and 5C depict views 500 of a self-centering hydraulic plunger, brake piston and piston seat washer, in accordance with an embodiment of the present disclosure. FIG. 5A depicts an exploded front view, FIG. 5B depicts an exploded cross-sectional view, and FIG. 5C depicts an exploded perspective view.

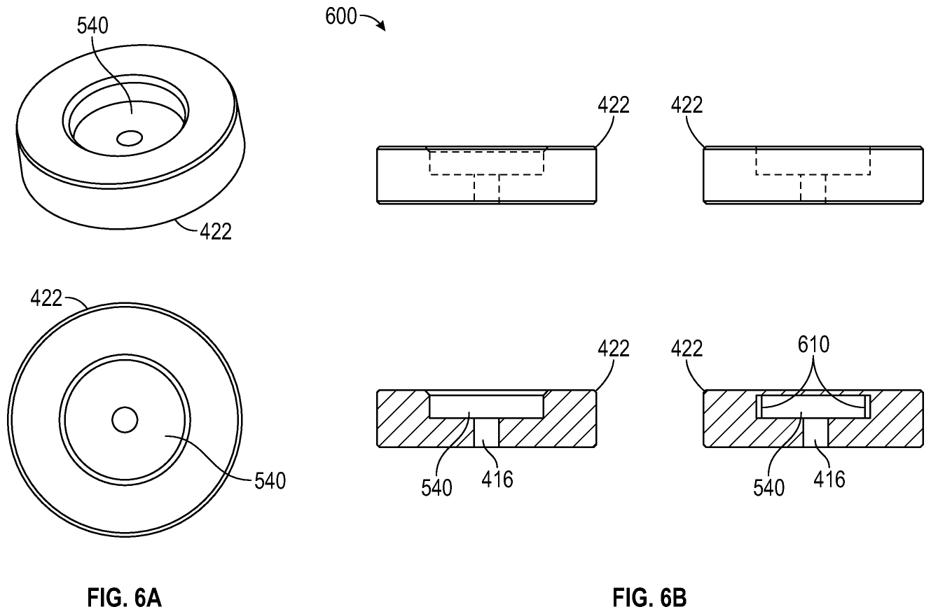

FIGS. 6A and 6B depict views 600 of a piston seat washer, in accordance with an embodiment of the present disclosure. FIG. 6A depicts isometric and top views and FIG. 6B depicts front and cross-sectional views.

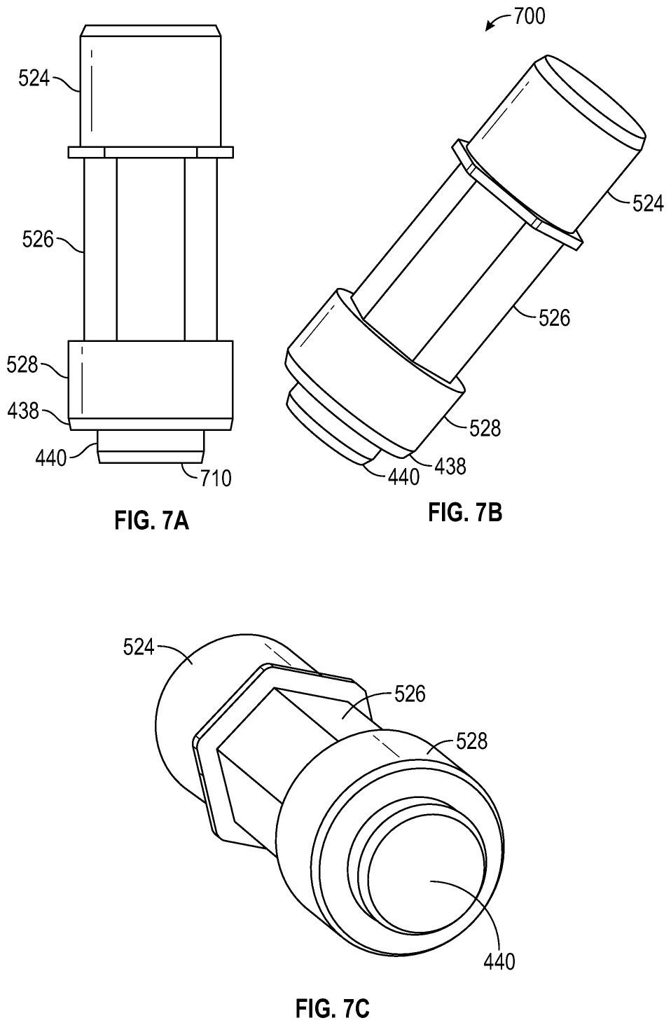

FIGS. 7A, 7B and 7C depict views 700 of a self-centering hydraulic plunger, in accordance with an embodiment of the present disclosure. FIG. 7A depicts a front view, FIG. 7B depicts a perspective front view, and FIG. 7C depicts an isometric view.

As depicted in FIG. 7A, self-centering hydraulic plunger 408 includes upper section 524 with an upper surface that contacts the hydraulic piston, middle section 526, and lower section 528 with shoulder 438 and reduced-diameter interface section 440 with lower surface 710. As depicted in FIG. 4A, reduced-diameter interface section 440 contacts piston seat washer 422 disposed within brake piston 418. Returning to FIG. 7A, the lower portion of reduced-diameter interface section 440 may include a bevel to assist in centering self-centering hydraulic plunger 408 within piston seat washer 422. The lower portion of shoulder 438 may also include a bevel. Advantageously, self-centering hydraulic plunger 408 may be remanufactured from hydraulic plunger 208 depicted in FIGS. 2B, 3A, 3B, and 3C.

As depicted in FIG. 5B, brake piston 418 has a cylindrical body, a side wall that defines an inner space, an open upper end and a closed lower end or base. The base of the brake piston includes an interior surface or piston seat 542, an exterior surface to which brake friction pad 424 is attached, O-ring groove 412, and central hole 423, which is threaded for ease of extraction of brake piston 418. Central hole 423 may be, for example, a M16×2.0 hole. Advantageously, the increased thickness of the lower surface or base of brake piston 418 enables central hole 423 to be longer and have greater diameter, enabling greater extraction force to be applied to brake piston 418 without stripping the threads of central hole 423.

Piston seat washer 422 is disposed within brake piston 418 and contacts (or rests on) the entire lower interior surface or brake piston seat 542. Piston seat washer 422 is a cylindrical disk that includes upper, recessed interface section 540 to receive reduced-diameter interface section 440 of self-centering hydraulic plunger 408. As depicted in FIG. 4B, the lower surface of reduced-diameter interface section 440 of self-centering hydraulic plunger 408 contacts the upper surface of recessed interface section 540 of piston seat washer 422, and at least a portion of the outer circumference of reduced-diameter interface section 440 of self-centering hydraulic plunger 408 contacts the vertical surface of the recessed interface section 540 of piston seat washer 422, at contact surface(s) 436. Interface section 440 of self-centering hydraulic plunger 408 has a length that provides a small (e.g., 2 mm) gap 434 between shoulder 438 of lower section 528 of hydraulic plunger 408 and the upper surface of piston seat washer 422. Coatings and or geometry can be applied to piston seat washer 422 to minimize friction. For example, piston seat washer 422 may be coated with PTFE or sprayed with Molykote D-321 to minimize friction. As depicted in FIG. 6B, guide bands 610 can also be installed to support side loads, as noted above.

Returning to FIG. 4B, brake friction pad 424 is attached to the lower exterior surface of brake piston 418 by adhesion over a series of matching concentric groves between brake piston 418 and brake friction pad 424. For ease of extraction, piston seat washer 422 includes hole 416. Hole 416 may be threaded.

Reduced-diameter interface section 440 of self-centering hydraulic plunger 408 favorably interacts with recessed interface section 440 of piston seat washer 422 to center self-centering hydraulic plunger 408, better distribute the load, minimize the torque transferred from brake piston 418 to self-centering hydraulic plunger 408, and support side loads of self-centering hydraulic plunger 408.

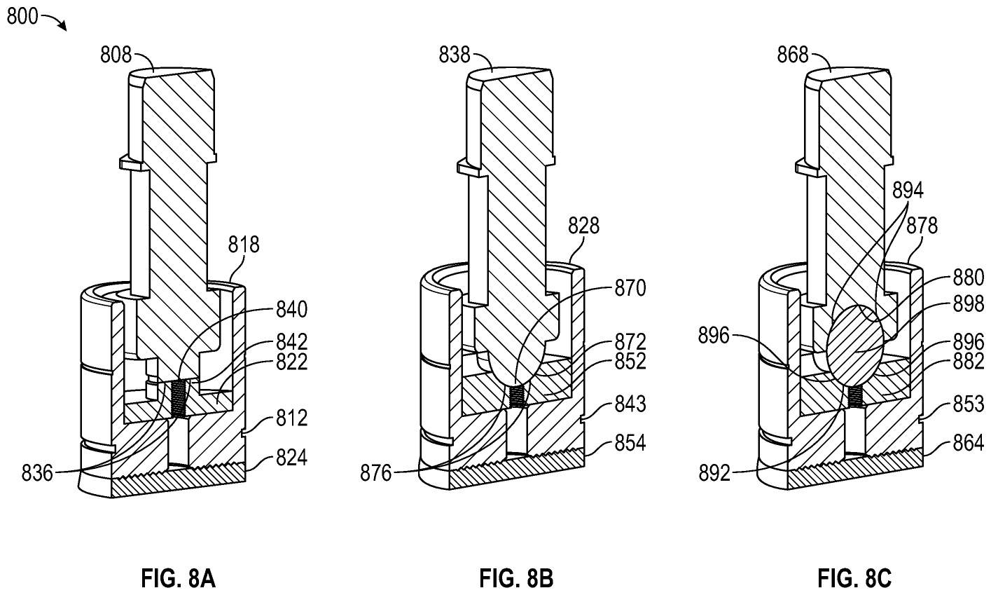

FIGS. 8A, 8B and 8C depict views 800 of a self-centering hydraulic plunger, brake piston, piston seat washer and brake friction pad, in accordance with embodiments of the present disclosure. FIG. 8A depicts a perspective cross-sectional view of self-centering hydraulic plunger 808, brake piston 818, piston seat washer 822 and brake friction pad 824, in accordance with an embodiment of the present disclosure.

In this embodiment, piston seat washer 822 includes a cylindrical body, a raised interface section 842 rather than a recessed interface section, and the lower surface of reduced-diameter interface section 840 of self-centering hydraulic plunger 808 contacts the upper surface of raised interface section 842 of piston seat washer 822 at contact surface 836. The diameter of the lower surface of reduced-diameter interface section 840 of self-centering hydraulic plunger 808 and the diameter of the upper surface of raised interface section 842 of piston seat washer 822 are substantially the same. In this embodiment, this diameter is smaller than the diameter of reduced-diameter interface section 440 of self-centering hydraulic plunger 408 in the embodiment depicted in FIGS. 4A, 4B, 5A, 5B, 7A, 7B and 7C. In other embodiments, this diameter may be the same or larger than reduced-diameter interface section 440 of self-centering hydraulic plunger 408 in the embodiment depicted in FIGS. 4A, 4B, 5A, 5B, 7A, 7B and 7C.

Brake piston 818 includes O-ring groove 812.

Reduced-diameter interface section 840 of self-centering hydraulic plunger 808 favorably interacts with raised interface section 842 of piston seat washer 822 to center self-centering hydraulic plunger 808, better distribute the load and minimize the torque transferred from brake friction pad 824 and brake piston 818 to self-centering hydraulic plunger 808.

FIG. 8B depicts a perspective cross-sectional view of self-centering hydraulic plunger 838, brake piston 828, piston seat washer 852 and brake friction pad 854, in accordance with another embodiment of the present disclosure.

In this embodiment, self-centering hydraulic plunger 838 includes a convex spherical reduced-diameter interface section 870, piston seat washer 852 includes a cylindrical body with concave spherical recessed interface section 872 that has substantially the same curvature as convex spherical reduced-diameter interface section 870. A substantial portion of convex spherical reduced-diameter interface section 870 contacts the concave spherical recessed interface section 872 at contact surface 876 to form a seated head joint or coupling. In this embodiment, the diameter of the upper portion of convex spherical reduced-diameter interface section 870 may be larger than the diameter of the reduced-diameter interface section 440 of self-centering hydraulic plunger 408 in the embodiment depicted in FIGS. 4A, 4B, 5A, 5B, 7A, 7B and 7C. In other embodiments, the diameter of the upper portion of convex spherical reduced-diameter interface section 870 may be the same or smaller than reduced-diameter interface section 440 of self-centering hydraulic plunger 408 in the embodiment depicted in FIGS. 4A, 4B, 5A, 5B, 7A, 7B and 7C.

Brake piston 828 includes O-ring groove 843.

Convex spherical reduced-diameter interface section 870 of self-centering hydraulic plunger 838 favorably interacts with concave spherical recessed interface section 872 of piston seat washer 852 to center self-centering hydraulic plunger 838, better distribute the load, minimize the torque transferred from brake friction pad 854 and brake piston 828 to self-centering hydraulic plunger 838, and support side loads of self-centering hydraulic plunger 838.

FIG. 8C depicts a perspective cross-sectional view of self-centering hydraulic plunger 868, brake piston 878, piston seat washer 882 and brake friction pad 864, in accordance with another embodiment of the present disclosure.

In this embodiment, self-centering hydraulic plunger 868 includes concave spherical recessed interface section 880, piston seat washer 882 includes a cylindrical body with corresponding concave spherical recessed interface section 892, and the curvatures of each interface section are substantially the same. Ball bearing 898 with substantially the same curvature is disposed between self-centering hydraulic plunger 868 and piston seat washer 882 and contacts a portion of each concave spherical recessed interface section at contact surface(s) 894 and contact surface(s) 896 to form a ball-and-socket joint or coupling. In this embodiment, self-centering hydraulic plunger 868 does not include a reduced-diameter interface section.

Brake piston 878 includes O-ring groove 853.

Concave spherical recessed interface section 880 of self-centering hydraulic plunger 868 and concave spherical recessed interface section 892 of piston seat washer 882 favorably interact with ball bearing 898 to center self-centering hydraulic plunger 868, better distribute the load, minimize the torque transferred from brake friction pad 864 and brake piston 878 to self-centering hydraulic plunger 868, and support side loads of self-centering hydraulic plunger 868.

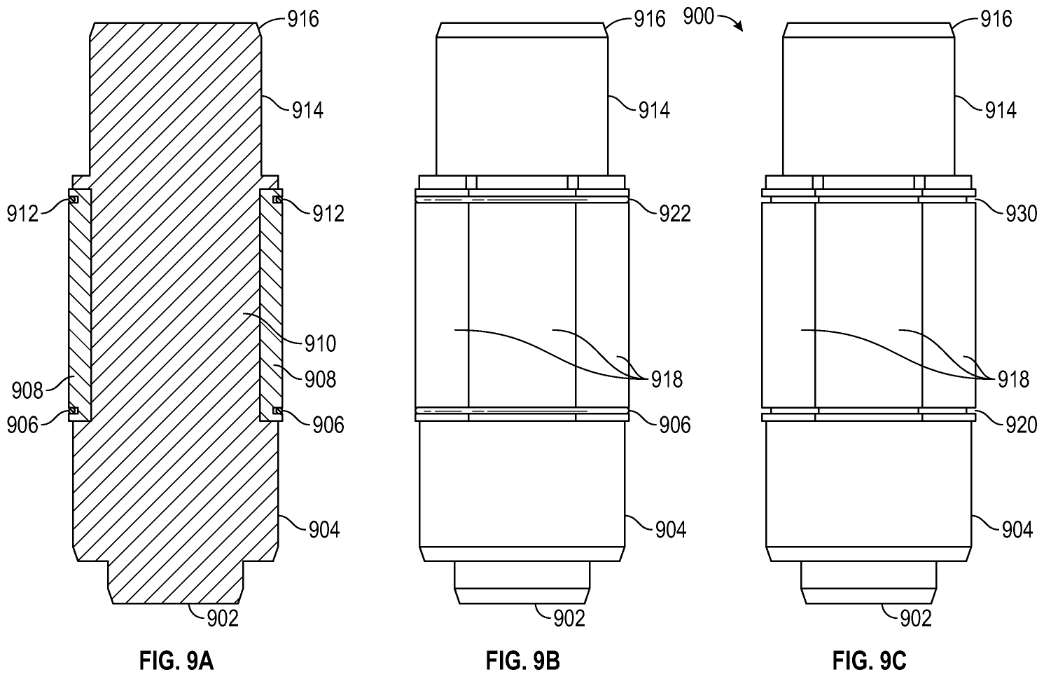

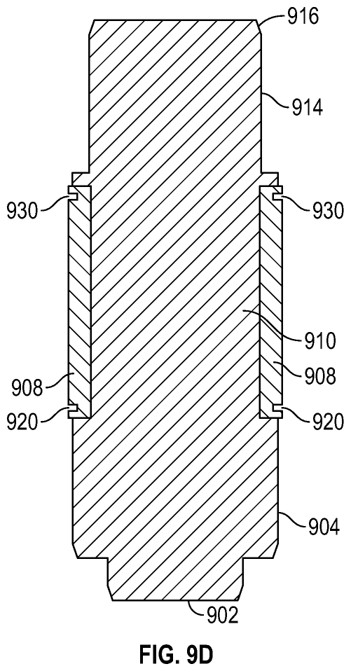

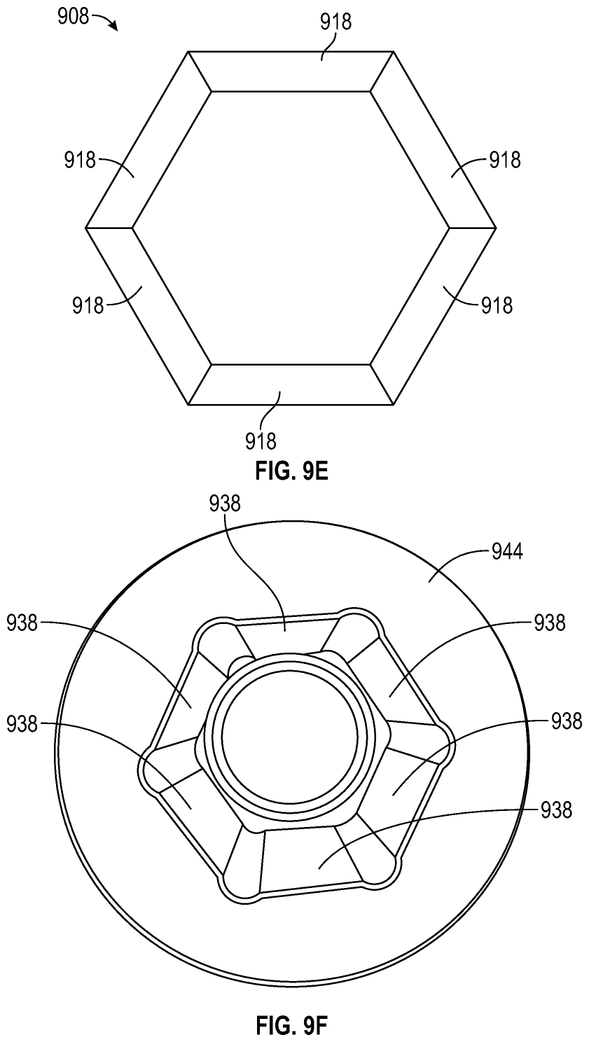

FIGS. 9A-9F depict views 900 of a self-centering hydraulic plunger and friction sleeve assembly (FIGS. 9A-9D), a friction sleeve assembly (FIG. 9E), and a yaw brake housing (FIG. 9F), in accordance with an embodiment of the present disclosure.

FIG. 9A depicts a cross section view of self-centering hydraulic plunger 902 and a friction sleeve assembly 908 with O-ring 906 and O-ring 912. FIG. 9B depicts a front view of self-centering hydraulic plunger 902 and sleeve portions 918, with O-ring 906 and O-ring 912. FIG. 9C depicts a front view of self-centering hydraulic plunger 902 and sleeve portions 918 without placement of O-ring 906 and O-ring 912. FIG. 9D depicts a cross section view of self-centering hydraulic plunger 902 and friction sleeve assembly 908 without placement of O-ring 906 and O-ring 912. FIG. 9E depicts a cross section view of friction sleeve assembly 908, showing sleeve portions 918. FIG. 9F depicts an exterior view, from below, of yaw brake housing 944.

In the embodiments of FIGS. 9A-9F, friction sleeve assembly 908 is disposed between middle section 910 of self-centering hydraulic plunger 902 and the portion of yaw brake housing 944 having a hexagonal cross section (shown in FIG. 9F). Self-centering hydraulic plunger 902 may be, for example, any of self-centering hydraulic plunger 408, plunger 808, plunger 838, plunger 868, etc.; middle section 910 may be, for example, middle section 526. Advantageously, friction sleeve assembly 908 improves load distribution at the plunger-housing interface by improving sliding contact surface area and, additionally, provides lubrication. Both extend the service life of the yaw brake.

As shown in FIGS. 9A, 9B, 9C and 9D, O-ring 906 and O-ring 912 are used as a means of assembly. Friction sleeve assembly 908 is comprised of six sleeve portions 918, placed around the hexagonal middle section of self-centering hydraulic plunger 902, with one sleeve portion 918 for each side of the hexagon. Each sleeve portion 918 has a groove 920 near its upper edge and a groove 930 near its lower edge; groove 920 accepts O-ring 906 and groove 930 accepts O-ring 912. With all six sleeve portions in place, O-ring 906 is placed around self-centering hydraulic plunger 902 and into groove 920 of friction sleeve assembly 908; O-ring 912 is similarly placed into groove 930. O-ring 906 and O-ring 912, under tension, then keep sleeve portions 918 in place, holding them against the hydraulic plunger 902.

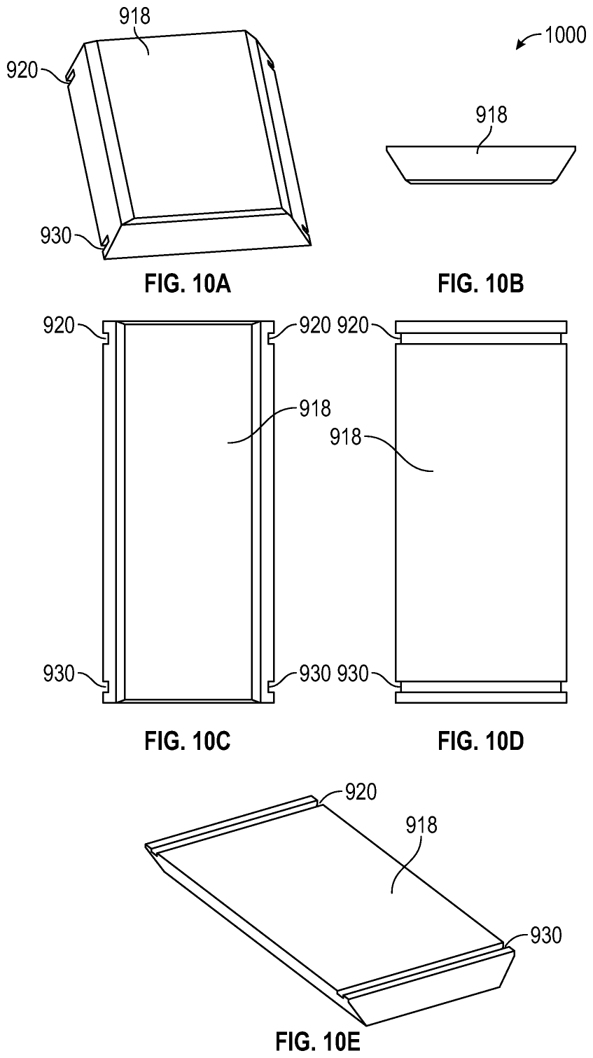

FIGS. 10A to 10E depict views 1000 of sleeve portion 918, in accordance with an embodiment of the present disclosure. FIG. 10A depicts an isometric view, FIG. 10B depicts a plan view, FIG. 10C depicts a back view, FIG. 10D depicts a front view and FIG. 10E depicts another isometric view.

Locations of groove 920 and groove 930 in sleeve portion 918, and bevels necessary for proper fit of sleeve portion 918 around the hexagonal cross section of the middle section 910 of self-centering hydraulic plunger 902, are shown in FIGS. 10A to 10E.

Due to the large rotational forces (torques) attempting to rotate the plunger within the housing, the material comprising the sleeve assembly must be carefully selected to achieve reliability and long service life. A suitable sleeve assembly material is a thermoset composite bearing material incorporating advanced polymer technologies (e.g., Orkot® C320, Orkot® C324, etc.). (Orkot® is a registered trademark of Trelleborg Sealing Solutions.) This material consists of technical fabrics (e.g., aramid fibers) impregnated with thermosetting resins, evenly dispersed solid lubricants (e.g., graphite, polytetrafluoroethylene (PTFE), etc.) and additional additives, and has several advantages over conventional sleeve materials in this application. The application requires that the material withstand high loads (ultimate compressive stress up to 300 N/mm²) with intermittent/oscillating movement, and provide excellent wear characteristics in a dry condition (i.e., without the presence of oil or grease). Tests have indicated a continuous running PV (pressure velocity) value for Orkot® C320 of 14 N/mm²·m/min when operating without oil or grease; this is a suitable value for this application.

The application further requires that the material have a low coefficient of friction, 0.15 to 0.35; be resistant to water, oils, and hydraulic fluid; and have excellent dimensional stability: The coefficient of thermal expansion perpendicular to laminations should be less than 10·10⁻⁵/° C. In addition, the rate of swelling in water, expressed as a percentage change of wall thickness after 1 year, should be <0.1%.

While the disclosure supra describes cross sections of the middle section 910 of self-centering hydraulic plunger 902 and a portion of yaw brake housing 944 as being hexagonal, other non-circular cross sections, e.g., triangular, quadrangular, pentangular, heptangular, etc., also are contemplated, with the number of sleeve portions 918 of friction sleeve assembly 908 comporting with the cross sections of self-centering hydraulic plunger 902 and yaw brake housing 944. Self-centering hydraulic plunger 902 may have a plurality of contiguous angled surfaces, e.g., hexagonal surfaces at middle section 910, and friction sleeve assembly 908 also may have a plurality of contiguous sleeve portions 918 that cover corresponding surfaces of self-centering hydraulic plunger 902 when friction sleeve assembly 908 is removably affixed to self-centering hydraulic plunger 902.

Friction sleeve assembly 908 may be removably affixed to surfaces of self-centering hydraulic plunger 902 by a number of attachment elements, e.g., O-ring 920 and O-ring 930, mechanical fasteners (e.g., screws, clips, clamps, etc.), adhesive applications, etc. Friction sleeve assembly 908 may be removably affixed to surfaces of the portion of yaw brake housing 944 having a hexagonal cross section.

While implementations of the disclosure are susceptible to embodiment in many different forms, there is shown in the drawings and will herein be described in detail specific embodiments, with the understanding that the present disclosure is to be considered as an example of the principles of the disclosure and not intended to limit the disclosure to the specific embodiments shown and described. In the description above, like reference numerals may be used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive. Also, grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. References to items in the singular should be understood to include items in the plural, and vice versa, unless explicitly stated otherwise or clear from the text.

Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” “for example,” or the like) provided herein, is intended merely to better illuminate the embodiments and does not pose a limitation on the scope of the embodiments. No language in the specification should be construed as indicating any unclaimed element as essential to the practice of the embodiments.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

In the following description, it is understood that terms such as “first,” “second,” “top,” “bottom,” “up,” “down,” “above,” “below,” and the like, are words of convenience and are not to be construed as limiting terms. Also, the terms apparatus, device, system, etc. may be used interchangeably in this text.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A yaw brake, comprising:
a self-centering hydraulic plunger including a reduced-diameter interface section;
a brake piston;
a piston seat washer, disposed within the brake piston, including a cylindrical body and an interface section in contact with, or coupled to, the reduced-diameter interface section of the self-centering hydraulic plunger; and
a brake friction pad attached to the brake piston.

2. The yaw brake according to claim 1, where the interface section of the piston seat washer is recessed into the cylindrical body of the piston seat washer.

3. The yaw brake according to claim 2, where the reduced-diameter interface section of the self-centering hydraulic plunger is convex spherical, and the recessed interface section of the piston seat washer is concave spherical and has the same curvature as the convex spherical reduced-diameter interface section.

4. The yaw brake according to claim 3, where a substantial portion of the convex spherical reduced-diameter interface section contacts the concave spherical recessed interface section of the piston seat washer to form a seated head joint or coupling.

5. The yaw brake according to claim 1, where the interface section of the piston seat washer is raised above the cylindrical body of the piston seat washer.

6. The yaw brake according to claim 5, where a lower surface of the reduced-diameter interface section of the self-centering hydraulic plunger contacts the upper surface of the raised interface section of the piston seat washer and the diameter of the lower surface of the reduced-diameter interface section of the self-centering hydraulic plunger and the diameter of the upper surface of the raised interface section of the piston seat washer are substantially the same.

7. The yaw brake according to claim 1, further comprising:
a housing, enclosing at least a middle section of the self-centering hydraulic plunger and having a housing cross section; and
a friction sleeve assembly disposed between the housing cross section and the middle section of the self-centering hydraulic plunger, the friction sleeve assembly including thermoset composite bearing material.

8. The yaw brake according to claim 7, the self-centering hydraulic plunger having a plurality of contiguous angled surfaces and the friction sleeve assembly further comprising a plurality of contiguous sleeve portions configured to cover corresponding ones of the plurality of contiguous angled surfaces when the friction sleeve assembly is removably affixed to the self-centering hydraulic plunger.

9. The yaw brake according to claim 8, further comprising a plurality of attachment elements configured to removably affix the friction sleeve assembly to the plurality of contiguous angled surfaces of the self-centering hydraulic plunger.

10. A hydraulic plunger assembly, comprising:
a self-centering hydraulic plunger including a reduced-diameter interface section; and
a piston seat washer, configured to be seated within a piston seat of a brake piston, including a cylindrical body and an interface section configured to receive the reduced-diameter interface section of the self-centering hydraulic plunger,
with the reduced-diameter interface section of the self-centering hydraulic plunger in contact with the interface section of the piston seat washer when the self-centering hydraulic plunger is seated at the piston seat washer, where a diameter of the interface section of the piston seat washer is less than an internal diameter of the brake piston.

11. The hydraulic plunger assembly of claim 10, where the interface section of the piston seat washer is recessed into the cylindrical body of the piston seat washer, forming a recessed interface section of the piston seat washer.

12. The hydraulic plunger assembly of claim 11, where the reduced-diameter interface section of the self-centering hydraulic plunger is convex spherical, and the recessed interface section of the piston seat washer is concave spherical and has the same curvature as the convex spherical reduced-diameter interface section.

13. The hydraulic plunger assembly according to claim 12, where a substantial portion of the convex spherical reduced-diameter interface section contacts the concave spherical recessed interface section of the piston seat washer to form a seated head joint or coupling.

14. The hydraulic plunger assembly of claim 10, where the interface section of the piston seat washer is raised above the cylindrical body of the piston seat washer, forming a raised interface section of the piston seat washer.

15. The hydraulic plunger assembly according to claim 14, where a lower surface of the reduced-diameter interface section of the self-centering hydraulic plunger contacts the upper surface of the raised interface section of the piston seat washer and the diameter of the lower surface of the reduced-diameter interface section of the self-centering hydraulic plunger and the diameter of the upper surface of the raised interface section of the piston seat washer are substantially the same.

16. The hydraulic plunger assembly according to claim 10, the self-centering hydraulic plunger having a plurality of contiguous angled surfaces and the hydraulic plunger assembly further comprising
a friction sleeve assembly of thermoset composite bearing material and having a plurality of contiguous sleeve portions configured to cover corresponding ones of the plurality of contiguous angled surfaces when the friction sleeve assembly is removably affixed to the self-centering hydraulic plunger.

17. The yaw brake according to claim 16, further comprising a plurality of attachment elements configured to removably affix the friction sleeve assembly to plurality of contiguous angled surfaces of the self-centering hydraulic plunger.

18. A hydraulic plunger assembly, comprising:
a self-centering hydraulic plunger including an interface section;
a piston seat washer, configured to be seated within a piston seat of a brake piston, including a cylindrical body and a recessed interface section, where a diameter of the recessed interface section of the piston seat washer is less than an internal diameter of the brake piston;
a ball bearing disposed between the self-centering hydraulic plunger and the piston seat washer, where:
the interface section of the self-centering hydraulic plunger is concave spherical,
the recessed interface section of the piston seat washer is concave spherical,
the ball bearing, interface section and recessed interface section all have the same curvature, and
the ball bearing contacts a portion of the interface section and a portion of the recessed interface section to form a ball-and-socket joint or coupling.

19. A yaw brake in accordance with claim 18, further comprising:
the brake piston; and
a brake friction pad attached to the brake piston.

20. The hydraulic plunger assembly according to claim 18, the self-centering hydraulic plunger having a plurality of contiguous angled surfaces and the hydraulic plunger assembly further comprising:
a friction sleeve assembly of thermoset composite bearing material having a plurality of contiguous sleeve portions configured to cover corresponding ones of the plurality of contiguous angled surfaces when the friction sleeve assembly is removably affixed to the self-centering hydraulic plunger.

21. The hydraulic plunger assembly according to claim 20, further comprising:
a plurality of attachment elements configured to removably affix the friction sleeve assembly to plurality of contiguous angled surfaces of the self-centering hydraulic plunger.

22. A friction sleeve assembly, comprising:
a plurality of contiguous sleeve portions configured to cover corresponding ones of a plurality of contiguous angled surfaces of a hydraulic plunger when the friction sleeve assembly is removably affixed to the hydraulic plunger, the contiguous sleeve portions of thermoset composite bearing material.

23. The friction sleeve assembly according to claim 22, further comprising a plurality of attachment elements configured to removably affix the friction sleeve assembly to the plurality of contiguous angled surfaces of the hydraulic plunger.

24. The friction sleeve assembly according to claim 22, where the thermoset composite bearing material has a coefficient of friction with a range of approximately 0.15 to 0.35.
